(19) United States
(12) Patent Application Publication
(10) Pub. No.: US 2026/0291822 A1
(43) Pub. Date: Sep. 24, 2026

(54) TECHNIQUE FOR SUBSCRIBER NUMBER ESTIMATION IN A NETWORK ANALYTICS CONTEXT

(71) Applicant: Telefonaktiebolaget LM Ericsson (publ), Stockholm (SE)

(72) Inventors: Gergely DÉVAI, Budapest (HU); Attila BÁDER, Paty (HU); Rafal PIOTROWSKI, Lódz (PL); Georgios ALMYRAS, Linköping (SE)

(73) Assignee: Telefonaktiebolaget LM Ericsson (publ), Stockholm (SE)

(21) Appl. No.: 19/476,205

(22) PCT Filed: Apr. 17, 2023
(86) PCT No.: PCT/EP2023/059936

§ 371 Date: Oct. 17, 2025

(51) Int. Cl. H04L 41/147; H04W 24/04

(52) U.S. Cl. CPC H04L 41/147; H04W 24/04

(57) ABSTRACT

A technique of subscriber number estimation in a network analytics context for a cellular communication network is presented. A method implementation of the technique comprises obtaining, for a set of cells of the cellular communication network and for a given reporting period, a local number of RRC connections per cell, and estimating, per cell, a local number of active subscribers from the local number of RRC connections of that cell. The method further comprises deriving aggregated information based on the estimated local numbers of active subscribers, and triggering network analytics based on the aggregated information or information derived therefrom.

### TECHNICAL FIELD

The present disclosure generally relates to communication networks and associated network analytics. In particular, a subscriber number estimation technique for network analytics is presented. The technique may be implemented as a method, a computer program product, an apparatus or a system.

### BACKGROUND

In modern communication networks, network analytics is part of a so-called network management domain and used to analyze service quality and other network-related aspects. Network analytics is used by different operational groups, such as network operation centers (NOCs), service operation centers (SOCs), and network optimization engineering (e.g., for network performance management).

Advanced network analytics solutions, such as the Ericsson Expert Analytics (EEA), collect and correlate elementary network events and related metrics to compute key performance indicators (KPIs) therefrom. Such network analytics solutions are configurable to associate KPI degradations with network-related problems for root cause detection.

Fast reaction times in the network management domain require network analytics solutions configured for real-time collection and correlation of network events. Besides powerful data collection and correlation functions capable of handling the resulting huge amount of information in real-time, such solutions also require advanced database technologies, sophisticated information processing engines and “big data” analytics processing capabilities. The amount of network events, especially those containing detailed user plane metrics, is large. For example, the event rate can be in the order of one or more Gbit/s for a larger communication network.

In order to efficiently detect service quality-related and other problems and identify the root cause for a large number of communication sessions, mobile network operators (MNOs) implement rules in their network analytics solutions. The rules are typically based on expert knowledge and trigger actions if, for example, a KPI degradation is detected. The triggered actions comprise a root cause analysis and associated network performance management steps.

An exemplary network analytics use case is a cell-specific service quality evaluation to detect possible problems in the domain of a radio access network (RAN). RAN problems (e.g., interference) and other network problems depend on cell load. Network analytics therefore benefits from an exact knowledge of the number of active subscribers in a cell during a given reporting period (of typically 1 to 15 minutes).

One simple way of determining the load of a cell is counting the number of successfully created radio resource control (RRC) connections within that cell and for given reporting period. The number of RRC connections in a cell is normally higher than the number of active subscribers in that cell because a terminal device may set up and release multiple RRC connections in the reporting period. In fact, RRC re-connections happen quite frequently as an RRC connection is normally released after an idle period (e.g., of 10 seconds) to save battery power and network resources. The number of RRC connections in a cell can therefore only provide an upper bound of the number of active subscribers, and this upper bound is not exact enough for many network analytics use cases.

An exact determination of the number of active subscribers can be performed by analyzing and correlating network events from the RAN domain and a core network (CN) domain of the communication network. In more detail, event information gathered in the CN domain (e.g., session- or flow-related information such as unique identifiers of terminal devices or subscribers) can be correlated with RRC-related event information gathered in the RAN domain to make sure that multiple RRC connections per active subscriber are not counted as multiple active subscribers. In this way, the number of active subscribers can exactly be calculated. However, as explained above, the number of network events that need to be evaluated and correlated to this end is massive and consumes significant processing and storage resources. For this reason, an exact determination of the number of active subscribers is in practice limited to a few cells, but not used at a larger scale.

A further reason why an exact determination of the number of active subscribers is not feasible in practice resides in the fact that events from multiple network domains need to be correlated. Since network events reported by the RAN domain do not contain an identifier of the subscriber or his/her terminal device, this missing information has to be derived from correlated network events detected in the CN domain so as to arrive at an exact subscriber count. If, however, the CN events required for this correlation are not available, the number of active subscribers cannot be exactly determined either. It has, for example, been found that not all CN nodes that serve active subscribers are covered by network analytics and, for this reason, the associated network events remain unreported. It may also occur that due to a particularly high load on the user plane of a CN, CN network events are lost or CN network event reporting is downregulated. Moreover, a spatial distribution of the reported (and of the missing) network events from the CN domain is uneven (e.g., may vary from cell to cell) and unknown.

As has become apparent from the above, it is in practice not feasible to determine an exact number of active subscribers for network analytics purposes for a larger portion of a cellular communication network.

### SUMMARY

Accordingly, there is a need for a technique of estimating the number of active subscribers in a network analytics context.

A first aspect relates to a method of subscriber number estimation in a network analytics context for a cellular communication network. The method comprises obtaining, for a set of cells of the cellular communication network and for a given reporting period, a local number of RRC connections per cell and estimating, per cell, a local number of active subscribers from the local number of RRC connections of that cell. The method further comprises deriving aggregated information based on the estimated local numbers of active subscribers and triggering network analytics based on the aggregated information or information derived therefrom.

The local numbers of active subscribers may be indicative of subscribers associated with a KPI degradation. The KPI degradation may in some variants affect a service quality as experienced by subscribers (including their terminal devices).

Deriving the aggregated information may comprise summing up the local numbers of active subscribers to determine an estimated total number of active subscribers. Deriving the aggregated information may comprise counting the cells having certain local numbers of active subscribers. The aggregated information may take the form of an estimated subscriber distribution.

Estimating the local number of active subscribers from the local number of RRC connections may comprise applying a first subscriber number correction which takes into account that a terminal device of an individual subscriber may have more than one RRC connection in the reporting period. The first subscriber number correction may be based on a relationship between a counted number of active subscribers and a counted number of RRC connections as determined for one or more cells in a calibration phase. The counted number of active subscribers may, for example, be determined based on an analysis of at least one of packet header logs (PHLs) and cell-trace records (CTRs) associated with the RRC connections.

The cellular communication network may comprise a radio access network domain and a core network domain. In such a case, the method may further comprise obtaining data records indicative of events correlated across the radio access network domain and the core network domain. At least a portion of the data records may include one or more KPIs of at least one of the radio access network domain and the core network domain. In such a variant, the method may further comprise evaluating the KPIs in the data records to determine the data records that are indicative of the KPI degradation (e.g., by applying a threshold decision).

The method may comprise determining an estimated total number of active subscribers associated with the KPI degradation from:
i. A counted total number, across the cells, of active subscribers;
ii. a counted total number, across the cells, of active subscribers; and
iii. the estimated total number of active subscribers.

In such a case, the estimated total number of active subscribers associated with the KPI degradation may be determined based on equating a first ratio of the counted total number of active subscribers associated with the KPI degradation and the counted total number of active subscribers and a second ratio of the estimated total number of active subscribers associated with the KPI degradation and the estimated total number of active subscribers. The KPI degradation may be due to a technical problem that is distributed substantially evenly among the cells in the communication network.

The method may comprise determining an estimated total number of active subscribers associated with the KPI degradation from:
i. a counted local number of active subscribers associated with the KPI degradation, per cell;
ii. a counted local number of active subscribers, per cell; and
iii. the estimated local number of active subscribers per cell.

In such a case, the estimated total number of active subscribers associated with the KPI degradation is determined by:
determining, for each cell, an estimated local number of active subscribers in that cell associated with the KPI degradation by multiplying, for that cell, the estimated local number active subscribers with a ratio of the counted local number of active subscribers associated with the KPI degradation and the counted local number of active subscribers; and
aggregating the estimated local numbers of active subscribers associated with the KPI degradation to obtain the estimated total number of active subscribers associated with the KPI degradation.

In the above case, the KPI degradation may due to a technical problem that is not distributed substantially evenly among the cells in the communication network (e.g., a failure of a network node of network function).

The method may comprise applying a second subscriber number correction based on the portion of data records including the one or more KPIs. In more detail, applying the second subscriber number correction may comprise a multiplication or division by the (e.g., counted total or local) portion of data records including the one or more KPIs. Less than all data records may include the one or more KPIs because, for one or more networks entities (e.g., network node or network function) that are to report the one or more KPIs or information required to determine the one or more KPIs, no events are available for correlation. In such a case, the applied second subscriber number correction may compensate for the unavailable events.

A second aspect relates to a method of subscriber number estimation in a network analytics context for a cellular communication network. The method comprises obtaining, for a set of cells of the cellular communication network and for a given reporting period, a local number of RRC connections per cell and deriving aggregated information based on the local numbers of RRC connections. The method further comprises estimating a total number of active subscribers from the aggregated information and triggering network analytics based on the total number of active subscribers or information derived therefrom.

In the second method aspect, deriving the aggregated information may comprise summing up the local numbers of RRC connections to determine a total number of RRC connections.

The total number of active subscribers may be indicative of subscribers associated with (e.g., affected by) a KPI degradation.

Estimating the total number of active subscribers from aggregated information may in the second method aspect comprise applying a first subscriber number correction which takes into account that a terminal device of an individual subscriber may have more than one RRC connection in the reporting period. The first subscriber number correction may be based on a relationship between a counted number of active subscribers and a counted number of RRC connections as determined for one or more cells in a calibration phase. The counted number of active subscribers may be determined based on an analysis of at least one of PHLs and CTRs associated with the RRC connections.

In the second method aspect, the cellular communication network may comprise a radio access network domain and a core network domain, and the method may further comprise obtaining data records indicative of events correlated across the radio access network domain and the core network domain. At least a portion of the data records may include one or more KPIs of at least one of the radio access network domain and the core network domain. In such an implementation, evaluating the KPIs in the data records to determine the data records that are indicative of the KPI degradation.

The method of the second aspect may comprise determining an estimated total number of active subscribers associated with the KPI degradation from:
i. a counted total number, across the cells, of active subscribers associated with the KPI degradation;
ii. a counted total number, across the cells, of active subscribers; and
iii. the estimated total number of active subscribers.

In such a case, the estimated total number of active subscribers associated with the KPI degradation is determined based on equating a first ratio of the counted total number of active subscribers associated with the KPI degradation and the counted total number of active subscribers and a second ratio of the estimated total number of active subscribers associated with the KPI degradation and the estimated total number of active subscribers. The KPI degradation may be due to a technical problem that is distributed substantially evenly among the cells in the communication network.

The second method aspect may comprise applying a second subscriber number correction based on the portion of data records including the one or more KPIs. Applying the second subscriber number correction may comprise a multiplication or division by the portion of data records including the one or more KPIs. Less than all data records may include the one or more KPIs because, for one or more networks nodes that are to report the one or more KPIs or information required to determine the one or more KPIs, no events are available for correlation. In this variant, the applied second subscriber number correction compensates for the unavailable events.

Also provided is a computer program product configured to perform the steps of any of the methods presented herein when the computer program product is executed one or more processors. The computer program product may be stored on a computer-readable recording medium.

Also provided is an apparatus for subscriber number estimation in a network analytics context for a cellular communication network. The apparatus is configured to obtain, for a set of cells of the cellular communication network and for a given reporting period, a local number of RRC connections per cell and to estimate, per cell, a local number of active subscribers from the local number of RRC connections of that cell. The apparatus is further configured to derive aggregated information based on the estimated local numbers of active subscribers, and to trigger network analytics based on the aggregated information or information derived therefrom.

The apparatus may be configured to perform the method of the first method aspect.

A second apparatus aspect provided an apparatus for subscriber number estimation in a network analytics context for a cellular communication network. The apparatus is configured to obtain, for a set of cells of the cellular communication network and for a given reporting period, a local number of radio resource control, RRC, connections per cell, and to derive aggregated information based on the local numbers of RRC connections. The apparatus is further configured to estimate a total number of active subscribers from the aggregated information, and to trigger network analytics based on the total number of active subscribers or information derived therefrom.

The apparatus of the second apparatus aspect may be configured to perform the method of the second method aspect.

A further aspect of the present disclosure relates to a communication network analytics system comprising the apparatus of at least one of the first and the second apparatus aspect.

A fourth aspect relates to a communication network system comprising the communication network analytics system presented herein and the communication network analyzed thereby.

### BRIEF DESCRIPTION OF THE DRAWINGS

Further aspects, details and advantages of the present disclosure will become apparent from the detailed description of exemplary embodiments below and from the drawings, wherein:

FIG. 1A is a diagram illustrating a first communication network system of the present disclosure;

FIG. 1B is a diagram illustrating a second communication network system of the present disclosure;

FIG. 2 is a diagram illustrating further details of a communication network system of the present disclosure;

FIG. 3 is a block diagram illustrating an estimating apparatus in accordance with the present disclosure;

FIG. 4A is a diagram of the phases involved in subscriber number estimation;

FIG. 4B is a diagram illustrating a regression-based correction approach;

FIG. 4C is a diagram illustrating a simulation-based correction approach;

FIG. 4D is a flow diagram of a first method realization of the present disclosure;

FIG. 4E is a flow diagram of a second method realization of the present disclosure;

FIG. 5 is a first histogrammatic representation in accordance with the present disclosure;

FIG. 6 is a first histogrammatic representation in accordance with the present disclosure; and

FIG. 7 is a signalling diagram of an exemplary 5G implementation of the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, some embodiments of the following description focus on an exemplary network configuration in accordance with 5G specifications, the present disclosure is not limited in this regard. In particular, the present disclosure can also be implemented in other cellular communication networks (e.g., according to 4G specifications or “beyond 5G” specifications).

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by one or more processors.

In the following description of exemplary embodiments, the same reference numerals denote the same or similar components.

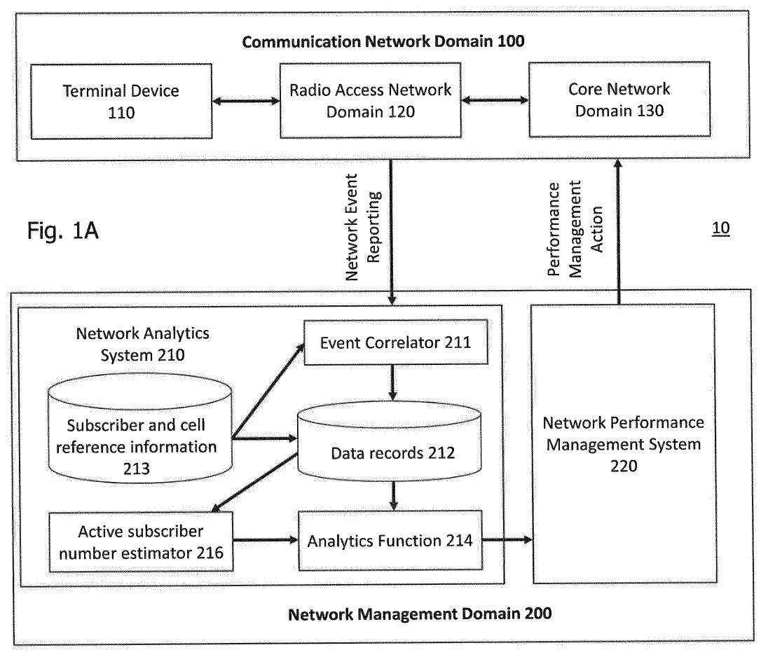

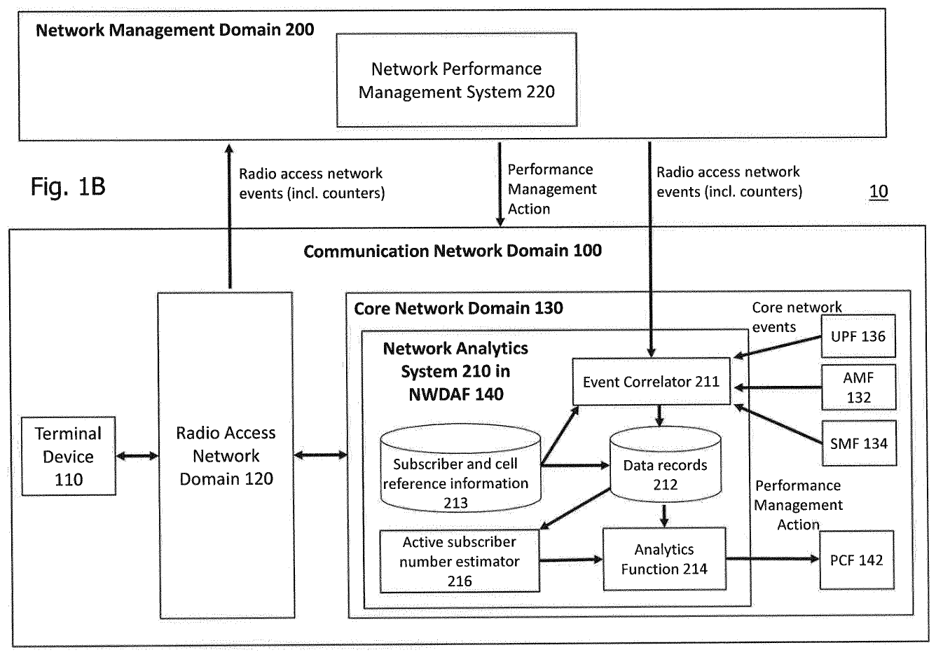

FIG. 1A illustrates an embodiment of a communication network system 10 in which the present disclosure can be implemented. The system 10 comprises a communication network domain 100 configured to provide communication services as well as to monitor network traffic and related network events. The system 10 further comprises a network management domain 200 configured to analyze the monitoring results and to control traffic and event monitoring in the communication network domain 200. The network management domain 200 is further configured to trigger performance management actions in the communication network domain 100.

In the system embodiment of FIG. 1A, the communication network domain 100 is configured as a cellular communication network. As such, the communication network domain 100 comprises one or more wireless terminal devices 110 (also called user equipments, UEs), a radio access network (RAN) domain 120 and a core network (CN) domain 130. The RAN domain 120 and the CN domain 130 each comprises a large number of network functions (NFs). A particular NF may be a software entity (e.g., implemented using cloud computing resources), a stand-alone hardware entity (e.g., in the form a network node), or a combination thereof. In some variants, the NFs may conform to the definitions of “network functions” as standardized by the 3^{rd} Generation Partnership Project (3GPP) in its 5G specifications, but in other variants (e.g., in 4G implementations) this may not be the case. Exemplary 5G NFs of the CN domain 130 include a user plane function (UPF), a session management function (SMF), an access and mobility management function (AMF), a universal data repository (UDR) and so on. The RAN domain 120 can be configured to include base stations conforming to one or both of 4G and 5G specifications.

The communication network domain 100 is configured to report information on network events to the network management domain 200. In the context of the present disclosure, network events are to be construed broadly and include, for example, identifiers but also parameters, indicators, counters and other metrics gathered in the communicate network domain 100. Network events generally characterize what is happening in the communication network domain 100, such as session initiation or termination, the status of an ongoing session, transmission of a certain amount of data, and so on. So-called key performance indicators (KPIs) and other parameters, usually numeric values, can be reported as events “as such” or as characteristic parameters of one or more events, such as session initiation time, ratio of unsuccessful session initiations, the amount of transmitted bytes over a given amount of time, and so on. KPIs may also be calculated in the network management domain 200 based on network events reported by the communication network domain 100.

A network event can for example be reported when it is locally detected at a dedicated monitoring site (e.g., a dedicated NF) or in response to probing (e.g., by the network management domain 200). The network events can be standardized (e.g., 4G or 5G) signalling events or vendor-specific events (of, e.g., a network node acting as NF). Event probing may be performed in the communication network domain 100 to capture the events at a network interface, or to capture user plane traffic, sample it and generate user plane traffic metrics that are to be reported as one or more network events.

KPIs and other network event information can be calculated from, or attributed to, one or multiple network events. As an example, a handover failure can be reported in, or as, a network event. Exemplary KPIs calculated from this event or from multiple such events, locally in the communication network domain 100 or centrally in the network management domain 200, are a number of handover failures or a ratio of the handover failures and the total handovers in a certain period of time. As another example, an NF user plane probe may report a session-based throughput event every 5 seconds in a dedicated event report. An average throughput KPI can be calculated locally, or centrally, as the average of these throughputs for 1 minute, and a maximum throughput KPI can be calculated locally, or centrally, as the maximum of the reported throughputs in 1 minute.

With continued reference to FIG. 1A, the network management domain 200 in the present embodiment comprises a network analytics system 210 and a network performance management system 220. The network analytics system 220 is configured to receive events (including, e.g., counters) reported by the communication network domain 100. The network analytics system 220 is further configured to generate an incident message to the network performance management system 220 if a critical network condition is detected based on the reported events. The incident message may comprise a root cause indication and further information associated with the critical network condition.

The network performance management system 220 is configured to trigger an alarm or a network performance action responsive to the incident message. If needed, further manual root cause analysis is done in the network performance management system 220, such as a detailed investigation of network logs, to decide about a suitable network performance action. The network performance action is intended to resolve the root cause in the communication network domain 100 and may involve an automatic action or a manual interaction by network optimization engineering.

As illustrated in FIG. 1A, the network analytics system 210 may be configured for at least one of “per flow” and “per session” analytics. The network analytics system 210 comprises an event correlator 211 configured to correlate different events reported by the communication network domain 100 and possibly from different domains. As an example, one or more events from the RAN domain 120 may be correlated with one or more events from the CN domain. The events to be correlated may be reported by two, three of more different data sources.

The correlation performed by the event correlator 211 may include one or more of an event aggregation and an association of events that are related in at least one of a temporal and logical context. The temporal context may be defined by certain time resolution (e.g., one or more seconds or one or more minutes). The logical context may be defined by an individual communication session (e.g., by a dedicated session identifier), an individual data flow, a particular subscriber identifier, a particular terminal device identifier, and so on.

The event correlator 211 is in some variants configured to generate data records from the network events that can be correlated. The data records may be generated on a per-session basis, with each such data record containing information from the events correlated by the event correlator 211 for a particular session. One or more such data records may be generated per session. In other variants, the data records may be generated on a per-subscriber basis, a per-cell basis, or any other basis.

As shown in FIG. 1A, the data records generated by the event correlator 211 are stored in a database 212. The network event information or the content of the data records may in some variants be enhanced (i.e., enriched or supplemented) with further information pertaining for example to at least one of individual subscribers (e.g., subscriber identifiers, service level agreements, etc.) and individual cells (e.g., cell identifiers, geographical information, etc.). The further information may in some realizations be associated with a corresponding session for which a certain data record has been generated. The further information may be taken (e.g., by the event correlator 211 or another entity capable of data record enhancement) from a dedicated database 213 with subscriber and cell reference information. In FIG. 1A, the database 213 is shown to be a part of the analytics system 210, but it could in other implementations at least partially be located in the core network domain 130 (e.g., in the form of a UDR or similar core network database storing information on subscribers and/or cells).

An analytics function 214 of the analytics system 210 is configured to analyze the data records in the database 212 based on one or more predefined network analytics rules and to generate incident messages towards the network performance management system 220. An incident message will be generated by the analytics function 214 if a critical network condition is detected upon applying one or more rules to the information stored in the data records. The rules are applied to the information (e.g., KPI values) as included in the data records or to (e.g., aggregated or otherwise processed) information derived therefrom.

Each data record may include zero, one or more KPIs. The KPIs may be determined based on information obtained from the same data sources that provided the correlated network events or from one or more different data sources. As an example, the correlation may involve network events reported by the RAN domain 120 and a first data source in the CN domain (e.g., an SMF), and the KPIs may be determined based on information reported by a second data source in the CN domain (e.g., a UPF). This also means that if no network events can be reported by the first data source (e.g., because it is not covered by the network analytics system 210 or the network events are simply lost), no correlation can take place and no data record will be generated for the associated session.

In some variants, the network analytics system 210 is configured to receive information about radio resource control (RRC) connection setups. This information may be received in RAN domain events (e.g., as RRC events as reported by radio base stations) or in the form of performance management statistics counters from the performance management system 220).

FIG. 1B illustrates a communication network system 10 similar to the one shown in FIG. 1A. For this reason, only the major differences will be explained in the following.

In the scenario of FIG. 1B, the network analytics system 210 has been moved from the network management domain 200 to the core network domain 130. In more detail, the network analytics system 210 is implemented in a network data analytics function 140.

The event correlator 211 of the network analytics system 210 is configured to receive RAN domain events (e.g., counters) via the network management domain 200 (e.g., via the network performance management system 220). Moreover, the event correlator 211 is configured to receive CN domain events directly from the associated CN node or functions, such as AMF 132, SMF 134 or UPF 136.

The analytics function may report incidents either to the network performance management system (as explained above with reference to FIG. 1A), to a component in the CN domain 130 or to trigger performance management actions itself. In the example of FIG. 1, the analytics function 214 triggers a performance management action in relation to a policy control function (PCF) in the CN domain 130.

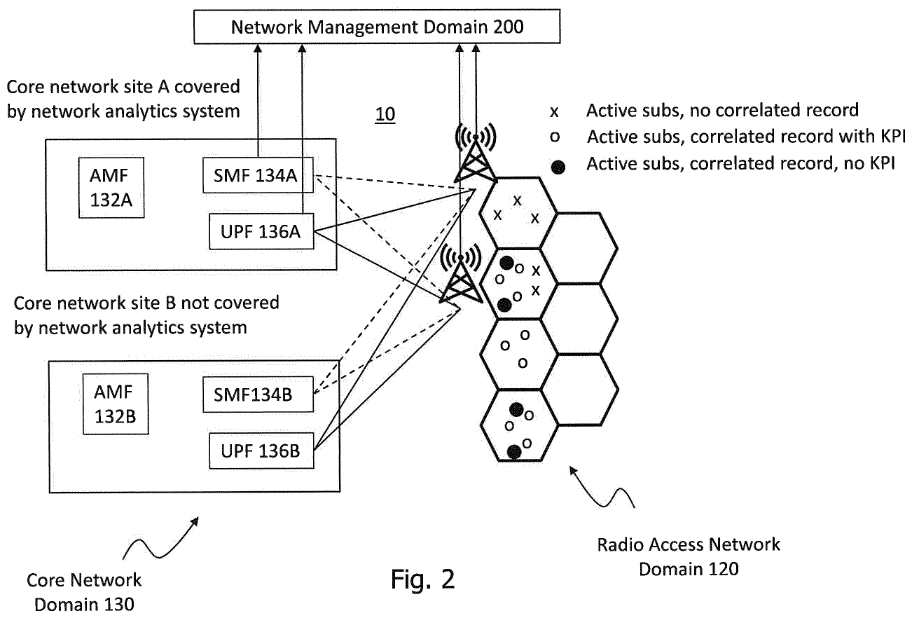

FIG. 2 illustrates an exemplary implementation of the communication network system 10 of FIG. 1A in a scenario in which only a portion of the CN domain 130 is covered by the entire network management domain 200 (in particular by the network analytics system 210). It will be appreciated that an implementation similar to that of FIG. 2 can be realized for the communication network system 10 of FIG. 1B (i.e., only a portion of the CN domain 130 is covered by the network analytics system 210 in the NWDAF 140).

As shown in FIG. 2, the CN domain 130 is deployed in multiple sites, wherein CN site A with AMF 132A, SMF 134A and UPF 136A is connected to the network analytics system 210 for event reporting, whereas CN site B with AMF 132B, SMF 134B and UPF 136B is not connected to the network analytics system 210. The RAN domain 120 is completely (or at least in the scope of a contiguous area) connected to the network analytics system 210. Since the network analytics system 210 will not receive event reports from CN site B, there will be no CN events available for correlation with reported RAN events for those terminal devices 110 that are served by CN site B. Of course, correlation also fails for terminal devices 110 that are served by CN site A if the serving cells are not connected to the network analytics system 210. In such a scenario, in particular RRC-related events will not be available.

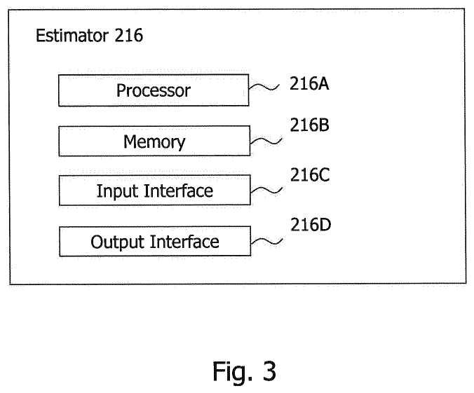

CN functions may not only be distributed among different sites, but can in addition, or alternatively, be used in pools. This means that a terminal device 110 can be served by any of the pooled AMF 132, SMF 134 and UPF 136. Assuming that the RAN domain 120 is at least substantially covered by the network analytics system 210, network event correlation and data record generation is possible if the SMF 134 serving a particular terminal device 110 is also covered by the network analytics system 210. This means that this terminal device 110 (and the associated subscriber) can be counted (or is “seen”) by the network analytics system 210. Such a data record will include a KPI of interest if the NF generating the network event on which the KPI is based (e.g., AMF 132 or UPF 136) is also connected to the network analytics system 210. Therefore, it can happen that for an individual active subscriber (see FIG. 3):
no correlated data record is generated (e.g., because the serving SMF 134 is not connected to the network analytics system 210),
correlated data records are generated, but a KPI of interest is not available (e.g., because while the serving SMF 134 is connected to the network analytics system 210, the serving UPF 136 is not), and
correlated data records including the KPI of interest are generated.

In a similar manner it can happen for a particular cell that (among others)
no active subscriber is seen in the cell (e.g., because no active subscribers are present or because no event correlation can be performed),
all active subscribers are seen and KPI of interest is calculated for all active subscribers,
all active subscribers are seen but KPI of interest is available for only a portion of them,
only a part of the active subscribers is seen and KPI of interest is available for only a portion of them.

In some of the above scenarios, it is not possible to determine the exact number of active subscribers for a given cell and in a given reporting period (of, e.g., 1 minute to 15 minutes) because not all active subscribers can be seen. Moreover, even if all active subscribers could be seen it may not be feasible to collect and correlate network events for a larger number of cells due to the associated processing and storage requirements. In such and other scenarios, the embodiments presented hereinafter permit at least a reliable estimation of the number of active subscribers. As understood herein, an estimated number of active subscribers is reliable in case it permits an efficient network analytics by the analytics function 214 (and associated network performance management).

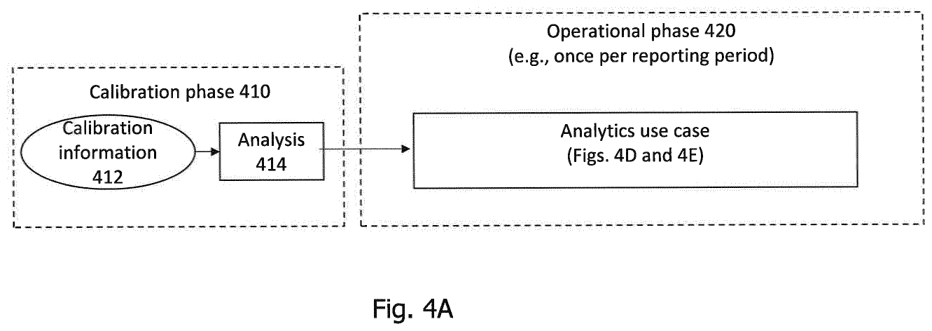

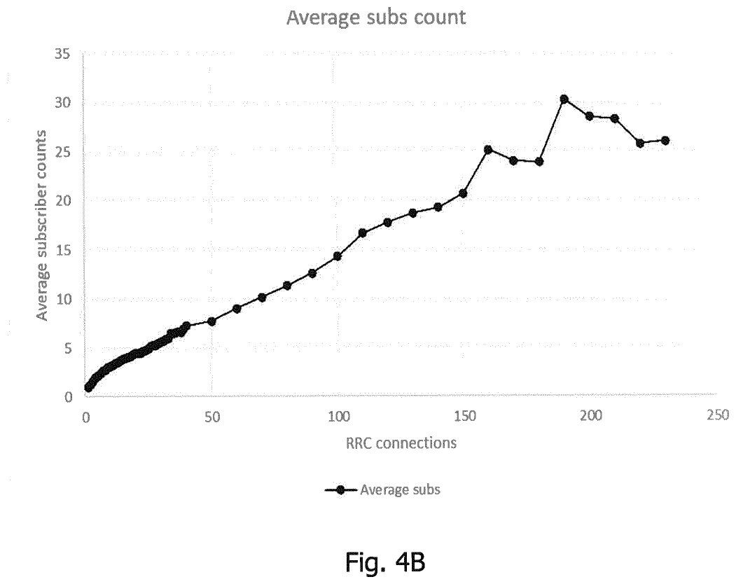

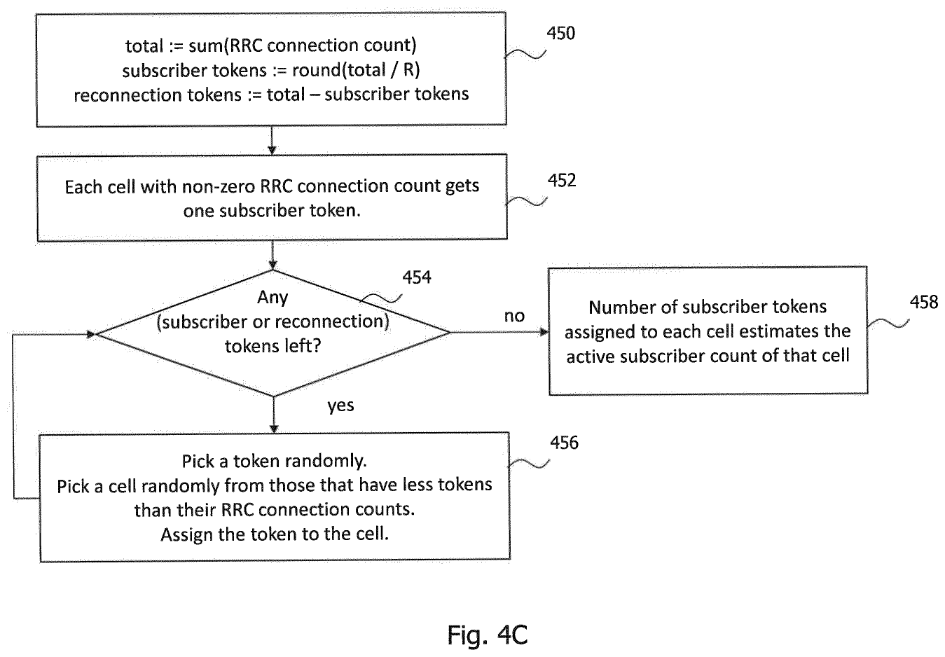

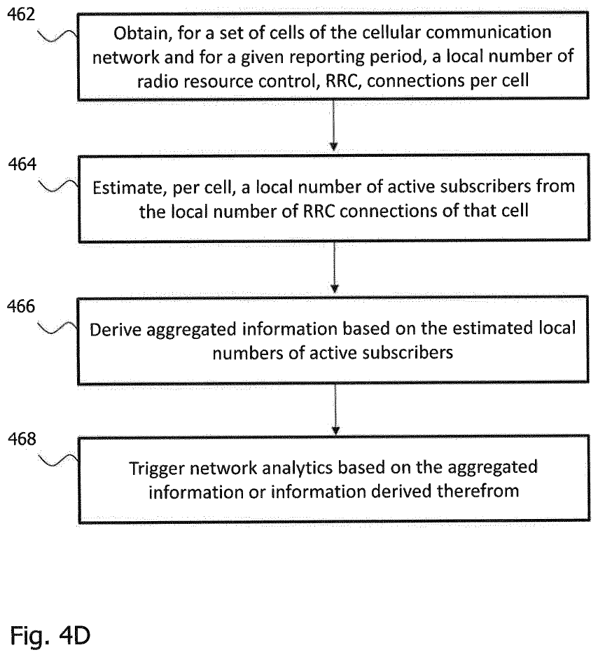

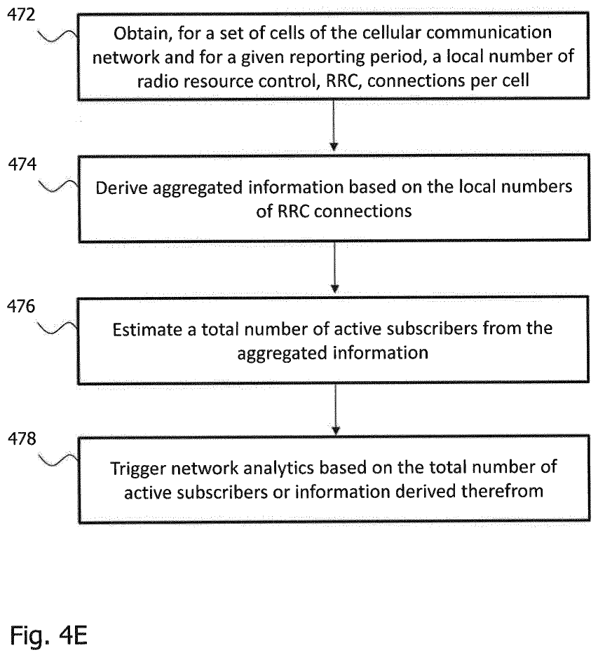

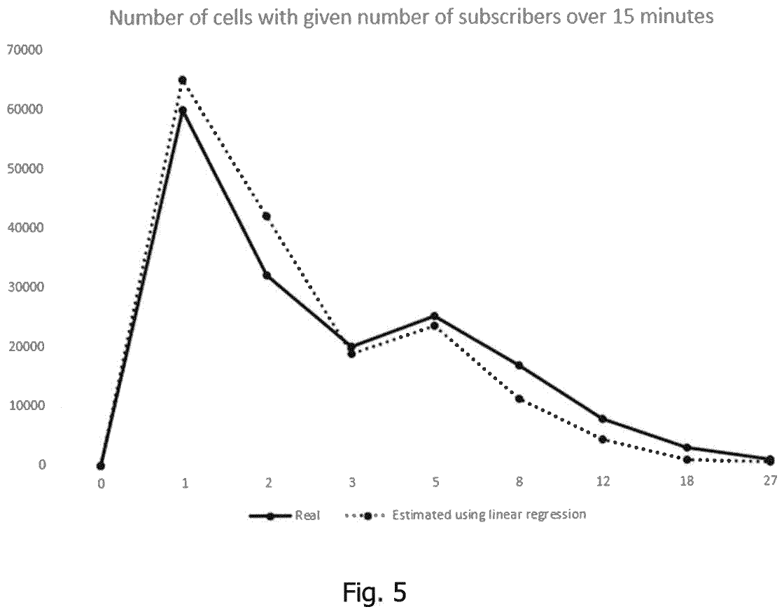

For estimating the number of active subscribers, and referring again to FIG. 1A or FIG. 1B, the network analytics system 210 comprises an estimator 216. The estimator 216 can be configured as a software component, a hardware component, or a combination thereof. In some variants, the estimator 216 is partially or fully integrated into the analytics function 214. A block diagram of an apparatus realization of the estimator 216 is shown in FIG. 3, and operational details of the estimator 216 will be described with reference to the method embodiments illustrated in FIGS. 4, 5A and 5B.

In the exemplary apparatus realization illustrated in FIG. 3, the estimator 216 comprises at least one processor 216A and a memory 216B coupled to the processor 216A. The memory 216B stores program code (e.g., in the form of a set of instructions) that controls operation of the processor 216A so that the estimator 216 is operative to perform any of the operational aspects presented herein (see, e.g., FIGS. 4, 5A and 5B). As understood herein, the processor 216A may be implemented using any processing circuitry, and is not limited to, for example, a single processing core, but may also have a distributed topology (e.g., using cloud computing resources). Moreover, the processor 216A may be configured to perform one or more further operational aspects of the analytics system 210, such as those of the analytics function 214.

The estimator 216 further comprises at least one input interface 216C and at least one output interface 216D. The interfaces 216C, 216D are configured for communication with other components of the network analytics system 210, such as the analytics function. The interfaces 216C, 216D may be hardware interfaces, software interfaces, or a combination thereof.

With reference to FIG. 4A, some implementations of the present disclosure comprise two dedicated phases, namely a calibration phase 410 and an operational phase 420. The calibration phase 410 typically precedes the operational phase 420 and can optionally be repeated one or more times during the operational phase 420. The operational phase 420 is typically an “on-demand” procedure or a cyclic procedure that is performed once for every reporting period (e.g., once per minute or once every 15 minutes). The operational phase 420 involves at least the estimator 216 and the analytics function 214, and the calibration phase 410 involves at least the analytics function 214 processing information contained in the data records 212 and possibly further information.

Turning now to the calibration phase 410, this procedure is typically performed once (or at least significantly less frequently than the operational phase 420) and for a limited number of (e.g., a representative set of) cells as it heavily consumes processing and storage resources.

The calibration phase begins with a step 412 of collecting calibration information for each cell of a selected cell set during regular network operation (i.e., from a “live” network). The calibration information can repeatedly be collected over several hours distributed over a day or several days.

The calibration information comprises, for a given period of time (e.g., for a typical reporting period from one up to 15 minutes) and a given cell, the actual number of RRC connection setup counts (as derived from network events reported by the RAN domain 120 or by performance management statistics counters of the performance management system 220) and the actual numbers of active subscribers counts in that period of time (as derived from, e.g., network events reported by the CN domain 130). As an example, packet header logs (PHLs) reported by the CN domain 130 provide information on packet flows with a sub-millisecond resolution and include a unique identifier for each active subscriber (e.g., in terms of an origin and/or destination identifier). Similar information can be gathered from an analysis of cell-trace records (CTRs).

The definition of a single RRC connection can be based on the definition of a threshold for the inter-arrival time between consecutive packets for the same terminal device 110. For example, a threshold of 10 seconds is aligned with the most typical value for RRC timeouts in a live network, wherein the respective cell setting (“inactivityTimer”) needs to be retrieved from each monitored cell for arriving at reliable count. The actual number of RRC connections during the given period of time is then calculated, and is partnered with the number of unique identifiers (i.e., the counted number of active subscribers) that have been seen in the period of time over which this information has been collected as illustrated in the following table:

| Reporting | | RRC connection | Active subscriber |
|---|---|---|---|
| period | Cell ID | count | count |
| 10:00-10:15 | Cell1234 | 200 | 41 |
| 10:00-10:15 | Cell1235 | 204 | 39 |
| 10:00-10:15 | Cell1236 | 126 | 35 |

There may be cases in which PHL data is not available for all the terminal devices 110 served by a particular cell (such as Cell1234 in the above table), but only a subset of the terminal devices 110 (e.g., 10%) are monitored. The corresponding percentage can be determined by comparing the actually collected RRC connection counts and the number calculated from the PHLs. The calculated number of active subscribers (“active subscriber count” in the above table) is then scaled according to this ratio.

Once the calibration information has been collected in step 412, it is analyzed in step 414 to determine how many times the terminal devices 110 reconnect during a given period of time. The resulting information forms the basis for estimating the number of active subscribers based on the number of RRC connections as in input parameter such that a correction is applied to compensate for the fact that terminal devices 110 typically perform more than one RRC connection setup in a given interval. The correction may be dependent on a cell load (e.g., as indicated by the number of RRC connections). The analysis step 414 may be performed in different ways, and in the following a regression-based approach and a simulation-based approach will be described in greater detail.

The regression-based approach uses the calibration information as collected in step 412 to compute the average number of subscribers as a function of the RRC connection counts (e.g., the number of successful RRC connection setups) as illustrated in FIG. 4B. For each non-negative integer R, if there are one or more records in the calibration information (see the table above) in which the RRC connection count equals R, we take the average of the corresponding number of active subscribers. This average is shown on the y axis of the diagram of FIG. 4B, and the corresponding value of R is shown on the x axis. The resulting diagram thus reflects the cell load. Since cells with a high load (i.e., a high R) are rare, for larger R values it can be practical to form intervals, take all records with RRC connection counts in that interval and compute the average number of active subscribers of those records.

In a further step, the resulting information is fit to a linear or non-linear function, thus computing the parameters of this function (which is also called regression). Once this function has been determined, it is used in the operational phase 420 to estimate the number of active subscribers for a given cell (or cell set) and for each reporting period (e.g., solely) based on the number of RRC connections determined for the respective reporting period.

The simulation-based approach applied in the analysis step 414 is illustrated in the flow diagram of FIG. 4C. Initially, the following ratio is calculated from the calibration information collected in step 412:

R=sum(RRC connection counts)/sum(active subscriber count)

Then (e.g., after each time interval), the token-based approach illustrated in FIG. 4C is performed. In a first step 450, based on the ratio R, a number of subscriber tokens and a number of reconnection tokes is determined. Each cell with a non-zero RRC connection count gets one subscriber token in step 452. As long as any tokens are left (see step 454), a reconnection or subscriber token is picked randomly and a cell is picked randomly from those that have less tokens than their RRC connection counts. The picked token is then assigned to the picked cell. When no more tokens are left (see step 454), the procedure is aborted and the number of subscriber tokens assigned to each cell estimates the active subscriber count of that cell (see step 458). In this manner, individual numbers of RRC connections (i.e., individual RRC connection counts) can be mapped on individual numbers of active subscribers (i.e., individual active subscriber counts).

As will be explained below in greater detail, deriving the number of active subscribers by simply applying, in the operational phase 420 illustrated in FIG. 4A, the results of the analysis step 414 to the number of RRC connections as determined for a particular cell and a particular reporting period is not yet exact enough for most network analytics purpose. In other words, the resulting correction which takes into account that a terminal device 110 may perform more than one RRC connection setup in the reporting period is not sufficient to arrive at a reliable number of active subscribers. It has been found that this deficiency can be overcome when the initial correction is followed by an aggregation step dependent on the particular network analytics use case. The aggregation step results in aggregated information that is accurate enough for many network analytics use cases.

Therefore, exemplary implementations of the operational phase 420 of FIG. 4A derive aggregated information in the context of subscriber number estimation for network analytics purposes. FIGS. 4D and 4E illustrate method implementations of how the aggregated information can be obtained. The method implementations may be performed by the estimator 216 illustrated in FIG. 1A or FIG. 1B.

With reference to FIG. 4D, one method implementation obtains, in step 462, for a set of cells of the cellular communication network and for a given reporting period, a local number of RRC connections per cell (e.g., in the form of a count of the successful RRC connection setups). This local number of RRC connections in an individual cell may, for example, be read from the data records 212 or may be determined separately by the network analytics system 210 for the purposes of the estimator 216.

Then, in step 464, the method proceeds with estimating, per cell, a local number of active subscribers from the local number of RRC connections of that cell. The estimation in step 464 is based on the result of the analysis step 414 in FIG. 4A. For example, the local number of RRC connections may be used as input for a regression function (see FIG. 4B) that outputs an associated local estimate of the number of active subscribers. As explained above, this correction of the number of RRC connections to determine the local number of active subscribers is typically not accurate enough for the purposes of the analytics function 214 in FIG. 1A or 1B.

Therefore, in a further step 466, the estimator 216 derives aggregated information based on the estimated local numbers of active subscribers. Various (e.g., use case-dependent) aggregation scenarios can be applied in step 466. As an example, deriving the aggregated information may comprise summing up the local numbers of active subscribers to determine an estimated total number of active subscribers across the set of cells. As a further example, deriving the aggregated information may comprises counting the cells having certain local numbers of active subscribers (e.g., to derive an estimated subscriber distribution).

In a further step 468, network analytics is triggered by the estimator 216 based on the aggregated information (or based on information derived therefrom). This triggering step may, for example, comprise forwarding the aggregated information, or the information derived therefrom, to the analytics function 214 of the network analytics system 210 of FIG. 1A or FIG. 1B.

With reference to FIG. 4E, another method implementation obtains, in step 472, for a set of cells of the cellular communication network and for a given reporting period, a local number of RRC connections per cell and derives, in step 474, aggregated information based on the local numbers of RRC connections. Deriving the aggregated information may comprise summing up the local numbers of RRC connections to determine a total number of RRC connections.

Then, in step 476, the estimator 216 estimates a total number of active subscribers from the aggregated information. This estimation is based on the result of the analysis step 414 in FIG. 4A. For example, the total number of RRC connections may be used as input for a regression function (see FIG. 4B) that outputs an associated total estimate of the number of active subscribers. Deviating from the method implementation illustrated in FIG. 4D, the correction is thus not applied to the local number of RRC connections, but to the total number. This means that the aggregation step if performed before the correction is applied.

Then, in step 478, network analytics is triggered based on the total number of active subscribers or information derived therefrom. This triggering step may comprise forwarding the total number of active subscribers (i.e., the aggregated information), or the information derived therefrom, to the analytics function 214 of the network analytics system 210 of FIG. 1A or FIG. 1B.

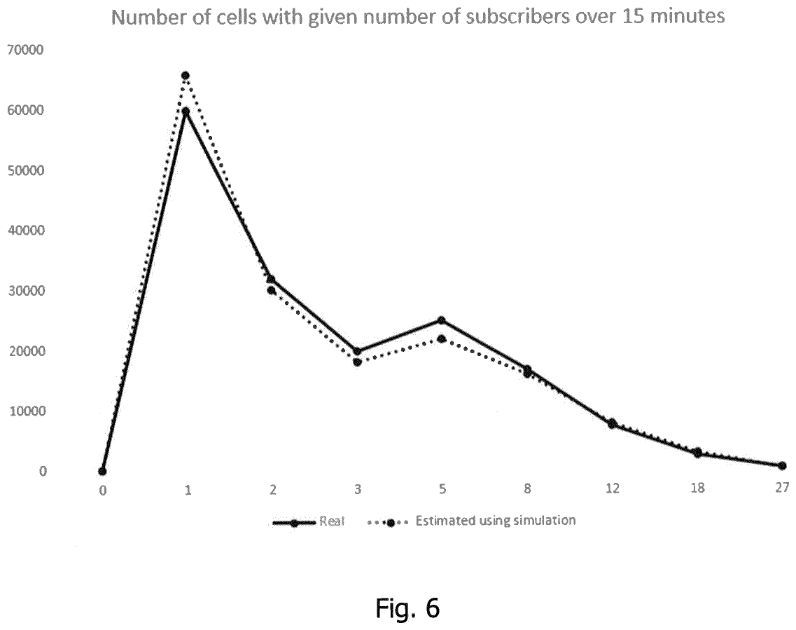

The aggregated information obtained in step 466 or step 474 can take various forms and may build the basis of various network analytics use cases. As an example, the aggregated information can take the form of a total number of active subscribers across a cell set (e.g., all cells of a given MNO or cells within a selected area). The aggregated information can also take the form of a subscriber distribution indicative of the number of active subscribers on the x axis and indicative of how many of the cells from the cell set have that many subscribers on the y axis, see the histograms of FIG. 5 and FIG. 6. Determining such distributions involves counting the cells having certain local numbers of active subscribers. The histograms of FIG. 5 and FIG. 6 additionally compare the exact number of subscribers with estimated values as derived by the method implementation of FIG. 4D and for a correction that is based on a linear regression (see FIG. 5) and for a correction that is based on a simulation (see FIG. 6). Cells with zero subscribers were filtered out in these histograms.

Similar histograms as illustrated in FIGS. 5 and 6 can be generated for a subset of all active subscribers. Such a subset may comprise those active subscribers that are associated with (e.g., affected by) a KPI degradation. The KPI degradation may be indicative of a service degradation from a subscriber's perspective, an internal technical problem of an MNO, and so on. In some variants, the KPI degradation is due to technical problems of a particular network node or NF (e.g., in the CN domain 130), or due to a network-wide problem (e.g., as a result of a new terminal device type or a new software version on a certain terminal device type). The estimator 216 may thus be configured to evaluate the one or more KPIs in the data records 212 for the active subscribers to determine those data records that are indicative of the KPI degradation. The evaluation may comprise a rule-based decision (e.g., a threshold decision or a more complex decision). Since the data records 212 will, in addition to the one or more KPIs, typically also include a terminal device identifier or subscriber identifier, the subset of active subscribers actually experiencing the KPI degradation can be determined. The total number of active subscribers associated with the KPI degradation may generally be determined from one or more of: the total number, across the cells, of data records indicative of the KPI degradation; a total number, across the cells, of data records; and the total number of active subscribers.

In the following, several network analytic use cases for the analytics function 214 as triggered by the estimator 216 based on the aggregated information, such as the total number of active subscribers, or information derived therefrom will be discussed. These use cases thus based on the total number of active subscribers, the subscriber distribution among the cells (see FIGS. 5 and 6) or the cell load. As explained with reference to FIG. 2, the network analytics system 210 typically does not cover the entire communication network domain 100. For example, it may be assumed that network events are only collected from a portion of the CN sites and/or a portion of the CN nodes or functions. Moreover, it may be assumed that network events are only collected from a set of cells operated by a particular MNO (e.g., the cells within a certain geographic area). It can thus happen that at least some terminal devices 110 served by a cell that reports network events to the network analytics system 210 are served by a CN site, node or function not connected to the network analytics system 210. In such a scenario, the network analytics system 210 cannot perform network event correlation for all terminal devices 110 and, as a result, cannot generate data records 212 for all session in that cell. This also means that the “real” number of active subscribers cannot be determined exactly as it may be higher than the counted number of active subscribers as determined from the data records 212 or other similar information sources. Therefore, subscriber number estimation techniques have to be applied.

A first network analytics use case is interested in the number of active subscribers associated with (e.g., affected by) a network-wide technical problem. It will be assumed that this technical problem is distributed substantially evenly in the communication network (i.e., does not depend on the characteristics of a particular cell). Such a technical problem can be the result of a deployment of a new terminal device type or of a software update for a particular terminal device type. The technical problem can be detected based on a dedicated KPI included in at least some of the data records 212, such as a throughput-related KPI. Since, in the example of FIG. 2, not all UPFs 136 may report a throughput-related metric to the network analytics system 210, only a portion of the data records 212 will include the throughput-related KPI of interest. Moreover, as explained above, no data records 212 will be available for subscriber sessions for which no event correlation can take place (e.g., because an individual SMF 134 is overloaded and has down-regulated event reporting). As such, there are at least two sources of uncertainty that prevent an exact determination of the total number of active subscribers from the available data records 212.

In the case of a network-wide technical problem, it can be assumed a ratio of the counted total number of active subscribers associated with the KPI degradation, as determined from the available data records 212 or other information sources, and the counted total number of active subscribers, as determined from the available data records 212 or other information sources, is a reliable indication for the fraction of the total (“real”) number of active subscribers associated with the KPI degradation. However, the total (“real”) number of active subscribers and the total (“real”) number of active subscribers associated with the KPI degradation are unknown.

Therefore, using any of the approaches discussed above with reference to FIG. 4D and FIG. 4E, the total number of active subscribers is estimated in a first stage (see step 466 with the aggregated information being the summed-up local subscriber numbers or step 476). As explained above, the aggregated information obtained by the approaches illustrated in FIG. 4D and FIG. 4E is accurate enough for forming the basis of a network analytics decision.

Then, in a second stage, the estimated total number of active subscribers associated with the KPI degradation (N_est_KPI) is determined based on equating the ratio of the counted total number of active subscribers associated with the KPI degradation, for example as determined from the data records 212, (N_datarec_KPI) and the counted total number of active subscribers, for example as determined from the data records 212, (N_datarec_total) and a ratio of the estimated total number of active subscribers associated with the KPI degradation (N_est_KPI) and the estimated total number of active subscribers (N_est_total). In other words:

$$N\_est \_KPI = ( N\_datarec \_KPI / N\_datarec \_total ) * N\_est \_total .$$

N_datarec_KPI and N_datarec_total can generally be determined based on existing mechanisms, for example from the data records 212. In other realizations, these numbers may be obtained from counters of network nodes or network functions. For example, N_datarec_total may be obtained by an SMF or AMF statistics counter, and N_datarec_KPI may be obtained by a UPF statistics counter. In this case only the counters of those nodes or functions will be summed, which are actually covered by the network analytics system 210.

There still is the challenge that only a portion x (e.g., x=0.8) of the data records 212 will include the KPI of interest, which can be solved by correcting the number of active subscribers associated with the KPI degradation based on the portion of data records 212 including the KPI. As explained with reference to FIG. 2, less than all data records 212 will include the KPI of interest because, for one or more networks entities (e.g., network sites, nodes or functions) that are to report the KPI (or information required to determine the KPI), no events may be available for correlation. Correcting the number of active subscribers associated with the KPI degradation compensates for the unavailable events.

Therefore, the estimated total number of active subscribers associated with the KPI degradation (i.e., N_est_KPI) is corrected based on the portion x of the data records 212 that include the KPI of interest as follows:

$$N\_est \_KPI \_corr = N\_est \_KPI / x .$$

Availability of the resulting value of N_est_KPI_corr may then trigger an evaluation by the analytics function 214. This evaluation may comprise a threshold decision. If, for example, N_est_KPI_corr exceeds a predefined threshold, the analytics function 214 may send an incident message towards the network performance management system 220 which, in turn, may trigger one or more performance management actions in the communication network domain 100 (e.g., a software update in one or both of the RAN domain 120 and the CN domain 130 so as to better serve a new terminal type).

A second network analytics use case is interested in the number of active subscribers associated with (e.g., affected by) a technical problem of a network site, node of function (e.g., in the CN domain 130). For example, the network analytics system 210 may be interested in the total number of active subscribers associated with a local technical problem in an AMF 132 or a UPF 136. In this scenario, the technical problem may be depend on cell load and, as a consequence, will not be distributed substantially evenly across all cells. It will therefore not be sufficient to multiply the estimated total number of active subscribers N_est_total with a constant ratio, as in the first network analytics use case. Rather, each cell has to be evaluated individually, before the aggregated information is derived. For this reason, the approach illustrated in FIG. 4E may not yield an exact result and the approach illustrated in FIG. 4D can be applied as follows.

In a first stage, for each cell the ratio of the counted local number of active subscribers associated with the KPI degradation, as determined from the data records 212 or otherwise, (N_datarec_KPI_local) and the counted local number of active subscribers, as determined from the data records 212 or otherwise, (N_datarec_local) is determined. The counted local number of active subscribers associated with the KPI degradation (N_datarec_local) may in some scenarios still need to be corrected based on the portion x of the data records 212 that include the KPI of interest (in a comparable manner as described above for the first use case):

$$N\_datarec \_KPI \_local \_corr = N\_datarec \_KPI \_local / x .$$

In the second stage, the estimated local number of active subscribers N_est_local in a given cell (see step 464 of FIG. 4D) is multiplied with the (corrected) ratio determined in the first stage for this cell so as to derive the estimated local number of active subscribers in this cell associated with the KPI degradation N_est_KPI_local as follows:

N_est_KPI_local=N_est_local*(N_datarec_KPI_local_corr/N_datarec_local).

The estimated local number of active subscribers associated with the KPI degradation N_est_KPI_local is still not considered exact enough for network analytics purposes. Therefore, in a third stage, an aggregation takes place to derive aggregated information (see step 466 of FIG. 4D), which has empirically been found to be sufficiently exact. In more detail, the estimated local numbers of active subscribers associated with the KPI degradation N_est_KPI_local as determined for the cells of the cell set are summed up. The resulting sum, i.e., the estimated total (or global) number of active subscribers associated with the KPI degradation is then handed over by the estimator 216 to the analytics function 214 to trigger network analytics. The analytics function 214 may subject this total number to a rule-based decision to decide whether or not an incident message towards the network performance management system 220 needs to be triggered.

The second network analytics use case can generally be used to determine the number of affected active subscribers when a KPI degradation depends on the cell load. For example, any service quality problem due to interference or bandwidth limitation can be detected by analyzing KPIs such as the “per session” throughput or the reference signal received power (RSRP) that depend on the number of active subscribers in an active cell.

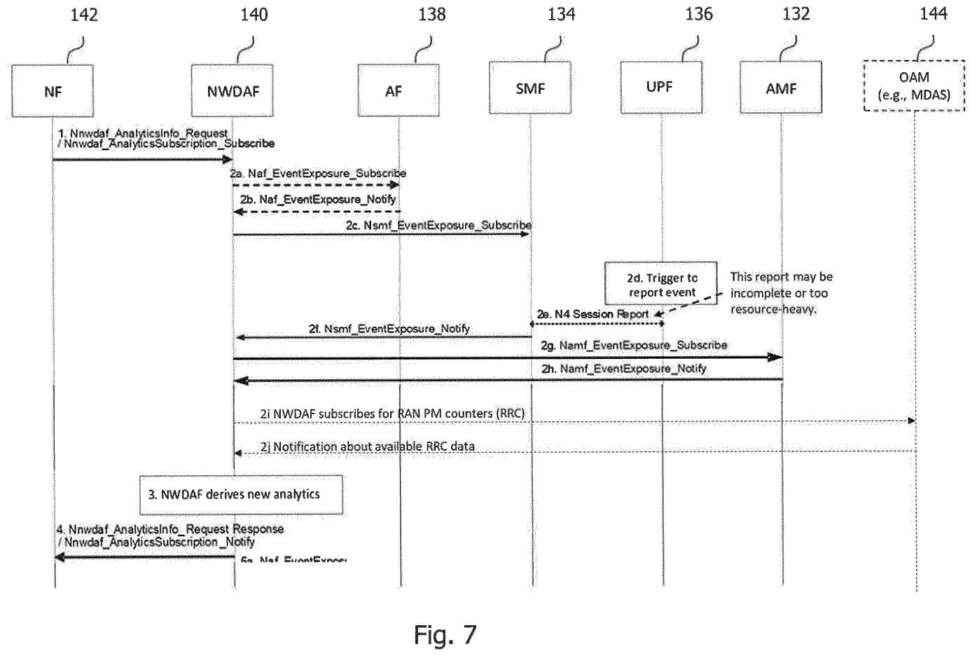

The estimation technique presented herein may be implemented in the context of a standardized 5G messaging scenario, such as the scenario described in 3GPP TS 23.288 V.17.6.0. FIG. 7 illustrates by dashed lines a possible extension of the standardized scenario involving, in addition to AMF 132, SMF 134, UPF 136 and NWDAF 140, an application function (AF) 138 and an NF 142 plus an operations, administration, and maintenance (OAM) system 144. The OAM system 144 may in some realizations be realized in, or as, the network management domain 200. For details of the standardized messaging scenario, reference is made to Sect. 6.7.3 and in particular Sect. 6.7.3.4 of 3GPP TS 23.288 V.17.6.0.

The scenario of FIG. 7 corresponds to the communication network system 10 of FIG. 1B, in which the network analytics system 210 is realized in the NWDAF 140. Such a realization makes it possible to roll-out the network analytics system 210 as part of the NWDAF 140. Such a realization is particularly useful if both the network analytics system 210 and the NWDAF 140 are provided by the same supplier, while the network management domain 200 is provided by a different supplier or the MNO.

In the standardized scenario, the N4 session report (see step 2e) may be incomplete due to partial network coverage. Moreover, this report may be lost or simply be omitted (e.g., because it is too resource heavy). In such a scenario, the NWDAF 140 obtains the RRC connection setup counters from the OAM system 144. To this end, the NWDAF 140 subscribes to the OAM system 144 for the corresponding RAN performance management counters in terms of RRC (see step 2i in FIG. 7). In return, the OAM system 144 responds with the available RRC data in step 2j—see steps 462 and 472 of FIG. 4D and FIG. 4E, respectively. The NWDAF 140 then performs the further steps explained above with reference to the estimator 216 and the related drawings.

As has become apparent from the above description of exemplary embodiments, the technique presented herein can efficiently be implemented in scenarios in which the network analytics system 210 is deployed only for a portion of the communication network domain 100 (e.g., in an initial deployment phase or for resource-efficient limited deployments). Empirical analyses have shown that the technique is beneficial for network analytics use cases that are based on aggregated information (e.g., the total number of active subscribers across a cell set). The technique is suited for different cell situations, including different cell types, different error conditions and different load situations.

The technique presented herein can efficiently be used to compensate for missing information in the network analytics system 210. It has, for example, been found that the number of active subscribers not “seen” by the network analytics system 210 also depends on the cell load (e.g., in terms of the number of RRC connections), and the cell load can efficiently be considered in the present technique. It is to be noted that a higher cell load can be due to multiple factors, including a higher number of active subscribers per cell area and better cell coverage. Moreover, the technique presented herein can also compensate for missing data records in the network analytics system 210 and for data records not containing one or more KPIs of interest (e.g., as a result of NFs being deployed in pools).

1. A method of subscriber number estimation in a network analytics context for a cellular communication network, comprising:
obtaining, for a set of cells of the cellular communication network and for a given reporting period, a local number of radio resource control, RRC, connections per cell;
estimating, per cell, a local number of active subscribers from the local number of RRC connections of that cell;
deriving aggregated information based on the estimated local numbers of active subscribers; and
triggering network analytics based on the aggregated information or information derived therefrom.

2. The method of claim 1, wherein
the local numbers of active subscribers are indicative of subscribers associated with a key performance indicator, KPI, degradation.

3. The method of claim 1, wherein deriving the aggregated information comprises summing up the local numbers of active subscribers to determine an estimated total number of active subscribers.

4. The method of claim 1, wherein deriving the aggregated information comprises counting the cells having certain local numbers of active subscribers, and
wherein the aggregated information takes the form of an estimated subscriber distribution.

5. (canceled)

6. The method of claim 1, wherein estimating the local number of active subscribers from the local number of RRC connections comprises applying a first subscriber number correction which takes into account that a terminal device of an individual subscriber may have more than one RRC connection in the reporting period.

7. The method of claim 6, wherein the first subscriber number correction is based on a relationship be tween a counted number of active subscribers and a counted number of RRC connections as determined for one or more cells in a calibration phase, and
wherein the counted number of active subscribers is determined based on an analysis of at least one of packet header logs, PHLs, and cell-trace records, CTRs, associated with the RRC connections.

8. (canceled)

9. The method of claim 1, wherein the cellular communication network comprises a radio access network domain and a core network domain, and further comprising
obtaining data records indicative of events correlated across the radio access network domain and the core network domain.

10. The method of claim 9, wherein
at least a portion of the data records includes one or more key performance indicators, KPIs, of at least one of the radio access network domain and the core network domain.

11. The method of claim 10, comprising
evaluating the KPIs in the data records to determine the data records that are indicative of a, or the, KPI degradation.

12. The method of claim 3, comprising:
determining an estimated total number of active subscribers associated with the KPI degradation from:
i. a counted total number, across the cells, of active subscribers associated with the KPI;
ii. a counted total number, across the cells, of active subscribers; and
iii. the estimated total number of active subscribers.

13. The method of claim 12, wherein
the estimated total number of active subscribers associated with the KPI degradation is determined based on equating a first ratio of the counted total number of active subscribers associated with the KPI degradation and the counted total number of active subscribers and a second ratio of the estimated total number of active subscribers associated with the KPI degradation and the estimated total number of active subscribers.

14. The method of claim 12, wherein
the KPI degradation is due to a technical problem that is distributed substantially evenly among the cells in the communication network.

15. The method of claim 1, comprising determining an estimated total number of active subscribers associated with the KPI degradation from:
i. a counted local number of active subscribers associated with the KPI degradation, per cell;
ii. a counted local number of active subscribers, per cell; and
iii. the estimated local number of active subscribers per cell.

16. The method of claim 15, wherein
the estimated total number of active subscribers associated with the KPI degradation is determined by:
i. determining, for each cell, an estimated local number of active subscribers in that cell associated with the KPI degradation by multiplying, for that cell, the estimated local number of active subscribers with a ratio of the counted local number of active subscribers associated with the KPI degradation and the count-ed local number of active subscribers; and
ii. aggregating the estimated local numbers of active subscribers associated with the KPI degradation to obtain the estimated total number of active subscribers associated with the KPI degradation.

17. The method of claim 15, wherein
the KPI degradation is due to a technical problem that is not distributed substantially evenly among the cells in the communication network.

18. The method of claim 11, comprising:
applying a second subscriber number correction based on the portion of data records including the one or more KPIs.

19. The method of claim 18, wherein:
applying the second subscriber number correction comprises a division or multiplication by the portion of data records including the one or more KPIs.

20. The method of claim 18, wherein less than all data records include the one or more KPIs because, for one or more networks entities that are to report the one or more KPIs or information required to determine the one or more KPIs, no events are available for correlation, and wherein
the applied second subscriber number correction compensates for the unavailable events.

21. A method of subscriber number estimation in a network analytics context for a cellular communication network, comprising
obtaining, for a set of cells of the cellular communication network and for a given reporting period, a local number of radio resource control, RRC, connections per cell;
deriving aggregated information based on the local numbers of RRC connections;
estimating a total number of active subscribers from the aggregated information; and
triggering network analytics based on the total number of active subscribers or information derived therefrom.

22-37. (canceled)

38. An apparatus for subscriber number estimation in a network analytics context for a cellular communication network, the apparatus being configured to
obtain, for a set of cells of the cellular communication network and for a given reporting period, a local number of radio resource control, RRC, connections per cell;
estimate, per cell, a local number of active subscribers from the local number of RRC connections of that cell;
derive aggregated information based on the estimated local numbers of active subscribers; and
trigger network analytics based on the aggregated information or in-formation derived therefrom.

39-43. (canceled)
